(19) United States
(12) Patent Application Publication
(10) Pub. No.: US 2006/0067223 A1
(43) Pub. Date: Mar. 30, 2006

(54) Transmission band control method and transmission band control system

(75) Inventors: Takumi Nomura, Tokyo (JP); Yukihiro Hara, Tokyo (JP); Kouji Tamimoto, Tokyo (JP)

Correspondence Address: Paul-J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/236,173

(22) Filed: Sep. 27, 2005

(30) Foreign Application Priority Data
Sep. 27, 2004 (JP) 2004-279424

(51) Int. Cl. H04L 12/26

(52) U.S. Cl. 370/232; 370/412

(57) ABSTRACT

Inputted packets are sorted into flows and a minimum guaranteed transmission band is set up for each flow. When a back pressure signal for limiting a supply of packets to an output port is generated, in each flow containing the packets to be supplied to the output port, if the input rate of the packets contained in that flow is equal to or less than a rate corresponding to the minimum guaranteed transmission band set in the flow, the packets contained in the flow is supplied to the output port at the same output rate as the input rate, and otherwise, the packets contained in the flow is supplied to the output port at an output rate corresponding to the minimum guaranteed transmission band set in the flow.

### BACKGROUND OF THE INVENTOIN

1. Field of the Invention

The present invention relates to a transmission band control method and transmission band control system for controlling the transmission band of a flow supplied from a certain port to another port in a router or the like and more particularly to a transmission band control method and transmission band control system for controlling the transmission band of a flow supplied from a certain port to another port in a chassis type router or the like.

2. Description of the Related Art

The chassis type router refers to a router having a structure in which plural line cards are connected through a back plane in terms of its physical structure. The back plane mentioned here refers to a substrate acting as a medium for connecting the plural functional blocks.

A chassis type router of a conventional example will be described with reference to FIG. 1.

The chassis type router of the conventional example comprises a switch fabric 901 and line cards 902-X, 902-Y, 902-Z connected to the switch fabric 901 through a back plane. The switch fabric mentioned here refers to a functional block for selecting an output port corresponding to the destination of a packet and sending the packet. Each line card 902 includes a back pressure receiving portion 911, a band control portion 912 and output port unit queues 913. Each output port unit queue 913 is a queue provided for each output port.

A packet inputted to the receiving portion of a certain line card is supplied to the sending portion of some line card according to header information of the packet or the like and sent out from that sending portion. Hereinafter, the receiving portion of the line card is called an up link line card while the sending portion of the line card is called a down link line card.

If the back pressure receiving portion 911 receives a back pressure signal 916 for limiting the supply of packets to its output port from the switch fabric 901, the back pressure receiving portion 911 analyzes the content of the back pressure signal 916 and if it is determined that the content is normal, the back pressure receiving portion 911 forwards the back pressure signal 916 to the band control portion 912.

The band control portion 912 supplies a control signal 918 to the output port unit queue 913 based on a received back pressure signal. The control signal 918 is used to stop an output from a queue which is a control object.

If the output port unit queue 913 receives the control signal 918 from the band control portion 912, the output port unit queue 913 stops sending packets to an output port which is a control object.

FIG. 1 shows an example that convergence 915 occurs in the output port for outputting packets to a line card #Z, and output of the packet from the queue, out of output port unit queues in the line card #X, for accumulating packets to be supplied to the line card # is stopped. The output of packets from a queue, out of the output port unit queues of other line cards #Y, #Z (not shown), for accumulating packets to be supplied to the line card #Z is also stopped.

According to an invention described in JP-A-2002-118559, a convergence detecting portion detects a convergence on ATM cell basis and a CPS packet abolishing portion abolishes data on CPS packet basis so as to grasp a load on a transmission line accurately and avoid reduction of data transmission efficiency, whereby the use efficiency of the band of the transmission line is improved. Further, the data abolition is carried out in accordance with abolition ratio. However, even if data is abolished in accordance with the abolition ratio, a minimum data transmission band cannot be always guaranteed.

Although the invention described in JP-A-2002-185501 has enabled guarantee of minimum transmission band and control of priority to be achieved at the same time, the minimum transmission band is not guaranteed at the up link circuit according to a back pressure signal from the output port.

A first invention described in JP-A-11-187072 determines an order of priority according to fee and flow amount in order to abolish packets at a probability based on the order of priority. Consequently, the minimum transmission band cannot be guaranteed.

A second invention described in JP-A-11-187072 abolishes packets in a larger flow-in amount in order to change plural flows having different flow-in amount to plural flows having the same flow-out amount. Consequently, the minimum transmission band cannot be guaranteed.

Although JPA-2004-522337 describes band width allocation technology which declares 100% transmission about a pipe smaller than the guaranteed minimum band width and allocates a band width fairly between pipes in which a provided load is over the guaranteed minimum value. However, it does not describe any invention which guarantees a minimum transmission band in the up link circuit according to the back pressure signal from the output port.

However, the conventional chassis type router has following problems.

When a contract is made between a communication common carrier and a user, a minimum guaranteed transmission band is often specified. The minimum guaranteed transmission band is a minimum value of transmission band which absolutely needs to be guaranteed. Therefore, if packet transmission is carried out at a transmission speed lower than that minimum guaranteed transmission band, violation of the contract occurs.

If the characteristic of packets which the router handles are analyzed based on information such as destination and user, the flow of a packet flowing into the router and sent from the router can be said to be an assembly of packet flows each having a different characteristic. As a conceptual terminology which distinguishes the packet flows by analyzing the characteristics of the packets, a word “flow” is used. More specifically, a flow exists for each combination of a destination and a user or a line number. A single user may use a single line number or a single user may user plural line numbers.

The destination is specified according to, for example, VLAN-ID of the destination. Generally, plural VLAN-IDs are allocated to a single line card which corresponds to a single output port. As an exception, if user is a heavy user, a single VLAN-ID may be allocated to a single line card. Therefore, if packets having a certain VLAN-ID as a destination VLAN-ID overflows, a back pressure signal is generated to not only a flow having that VLAN-ID but also all the flows each having VLAN-ID sharing an output port with that VLAN-ID.

In the chassis type having a structure in which the switch fabric and line cards are separated physically via the back plane, information contained in the back pressure signal is limited to information (output port discrimination information) for discriminating an output port in convergence condition. For the reason, each line card for up link cannot control nothing but stopping the output to a port in the convergence condition. If this control is performed, random packets are abolished in order to avoid convergence not taking any flow into consciousness and thus, packets in a certain flow are abolished more than necessary, so that the transmission band drops below the minimum guaranteed transmission band. That is, there was no effective method for achieving guarantee of the minimum transmission band of each flow and avoidance of convergence in a switch. Therefore, although band control in accordance with information on the order of priority of each packet is possible, a flow which should be a control object cannot be identified and consequently, band control by selecting a flow is impossible.

As an example, assume that a certain user for whom a minimum transmission band of 10 Mbps is guaranteed is communicating at 12 Mbps.

At this time, if other flows overlap, so that convergence is generated at a certain output port, it is necessary to so control to always pass 10 Mbps which is a guaranteed range of this user's flow and abolish only 2 Mbps which exceeds the minimum guaranteed transmission band. Unless control for such abolition can be achieved, communication common carrier cannot keep a guarantee scope relating to communication quality to user. Therefore, some communication common carriers provide a service fair to users by preparing communication equipment and communication line larger than necessary to prevent generation of convergence. Particularly, this can turn to a problem directly leading to cost for renting a communication line for a communication common carrier having no its own communication line.

On the other hand, a router in which a switch fabric and line cards re integrated physically (hereinafter referred to as box type router) can achieve guarantee of the minimum transmission band of each flow and avoidance of convergence in a switch relatively easily and these have been already achieved. Its first reason is that because the switch fabric, an output port in convergence condition and a band control portion are integrated physically, that is, all components for achieving each function are mounted on the same substrate, a means for transmitting a control signal from the output port to the band control portion can be implemented easily, so that the information amount possessed by the back pressure signal can be necessarily increased and not only output port discrimination information but also flow discrimination information for specifying a flow which should be limited can be supplied to the band control portion. Its second reason is that because the box type router is smaller than the chassis type router capable of accommodating plural pieces of the line cards, the number of flows which should be discriminated and the quantity of packets flowing into the unit necessarily decrease, so that logic for band control is simple and circuit size is small relatively.

In the two points described as the reasons, because the switch fabric in which convergence occurs and the line card for controlling the convergence are separated physically in the chassis type router, there are a number of restrictions for means for physically transmitting the back pressure signal.

Further, the chassis type router has such disadvantage that a circuit for detecting convergence, a circuit for generating control information, a circuit for controlling the band and the like become tremendously large in scale, because the number of expected flows and the number of packets flowing into the unit are large.

### SUMMARY OF THE INVENTION

Accordingly, an object of the invention is to provide a chassis type router which achieves guarantee of the minimum transmission band as well as avoidance of convergence by controlling the band in the unit of flow using a conventional switch fabric.

According to the present invention, there is provided a transmission band control method comprising the steps of sorting input packets into flows; setting a minimum guaranteed transmission band for each flow; and when a back pressure signal for limiting a supply of packets to an output port is generated, in each flow of one or more flows containing packets to be supplied to the output port, if an input rate of the packets contained in the flow is the same as or less than a rate corresponding to the minimum guaranteed transmission band set for the flow, supplying the packets contained in the flow to the output port at a same output rate as the input rate, while if the input rate of the packets contained in the flow exceeds the rate corresponding to the minimum guaranteed transmission band set for the flow, supplying the packets contained in the flow to the output port at an output rate corresponding to the minimum guaranteed transmission band set for the flow.

In the transmission band control method, the sorting may be made based on the output port to which each input packet is supplied and on a user or a line number related to the input packet.

In the transmission band control method, each output port may correspond to one or more VLAN-IDs.

In the transmission band control method, plural flows corresponding the same output port may be time-division multiplexed before supplied to the output port.

In the transmission band control method, the plural flows corresponding to the same output port may be time-division multiplexed among plural up link line cards.

In the transmission band control method, the plural flows corresponding to the same output port may be time-division multiplexed in a flow selecting circuit within each up link line card.

The transmission band control method may further comprise the step of determining a time ratio of the time-division multiplexing depending on the minimum guaranteed transmission bands of the plural flows.

The transmission band control method may further comprise the step of, if no packet exists in a certain flow, causing the flow selecting circuit to skip time allocation to the flow and to proceed to time allocation to a next flow.

In the transmission band control method, the plural flows time-division multiplexed by the flow selecting circuit may be additionally time-division multiplexed with plural flows supplied to other output ports in a port selecting circuit within each up link line card.

The transmission band control method may further comprise the step of determining a time ratio of the time-division multiplexing in the port selecting circuit depending on the minimum guaranteed transmission bands of port planes, wherein each port plane comprises plural flows corresponding to the same output port, and the minimum guaranteed transmission band of the port plane is a sum of the minimum guaranteed transmission bands each set for each flow in the port plane.

The transmission band control method may further comprise the step of reducing time allocation to plural flows supplied to an output port relating to the back pressure signal depending on the minimum guaranteed transmission band of the port plane, wherein the port plane comprises the plural flows supplied to the output port relating to the back pressure signal, and the minimum guaranteed transmission band of the port plane is a sum of the minimum guaranteed transmission bands each set for each flow in the port plane.

The transmission band control method may further comprise the step of allocating a residual time generated as a result of reducing the time allocation to the plural flows supplied to the output port relating to the back pressure signal to other port planes.

The transmission band control method may further comprise the steps of: setting a maximum limited transmission band for each flow; and
when no back pressure signal for limiting a supply of the packets to the output port is generated, in each flow of one or more flows containing packets to be supplied to the output port, if the input rate of the packets contained in the flow is the same as or less than a rate corresponding to the maximum limited transmission band set for flow, supplying the packets contained in the flow to the output port at a same output rate as the input rate, while if the input rate of the packets contained in the flow exceeds the rate corresponding to the maximum limited transmission band set for the flow, supplying the packets contained in the flow to the output port at an output rate corresponding to the maximum limited transmission band set for the flow.

### BRIEF DESCRIPTION OF THE DRAWINGS

FIG. 1 is a block diagram showing the structure of a conventional chassis type router;

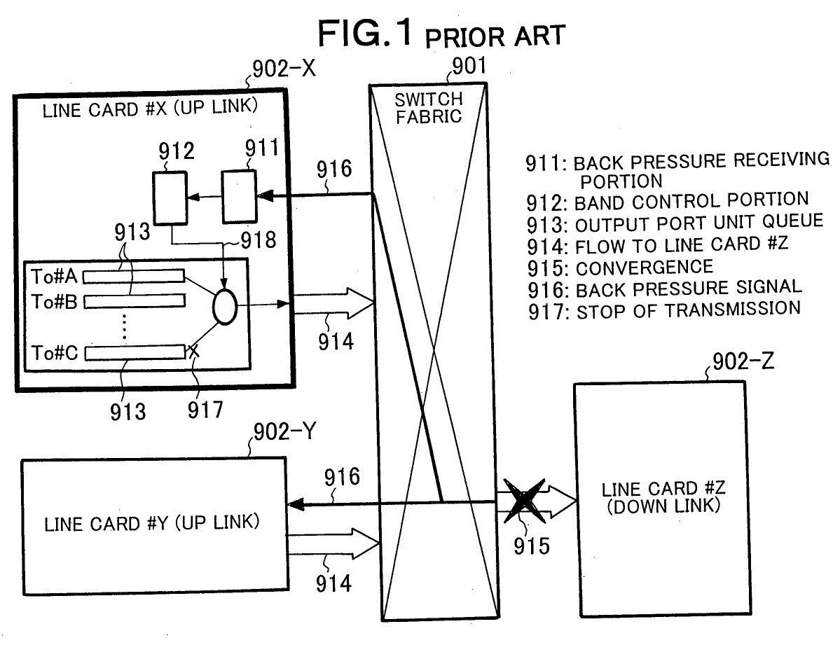

FIG. 2 is a block diagram showing the structure of a chassis type router according to a first embodiment of the present invention;

FIG. 3 is a block diagram showing the detailed structure of the up link line card shown in FIG. 2;

FIGS. 4A-4C are diagrams for explaining a restriction of rate according to the embodiment of the present invention; and

FIG. 5 is a block diagram showing the structure of a chassis type router according to a second embodiment of the present invention.

### DESCRIPTION OF THE PREFERRED EMBODIMETNS

Hereinafter, the preferred embodiments of the present invention will be described in detail with reference to the accompanying drawings.

### First Embodiment

In a chassis type router, the first embodiment has a feature in band control in such a case where convergence occurs in a down link card because packets overflow therein when the input frequency of packets exceeds the processing ability of the unit.

As described above, in the conventional chassis type router, its switch fabric notifies the up link line card of a back pressure signal and “stops” packet input temporarily so as to perform adaptive control for input packets exceeding the processing ability of a down link line card.

On the other hand, this embodiment has a feature in the control method not “stopping” the input packet but “limiting the flow amount” when convergence occurs, i.e., limiting the flow amount based on minimum guaranteed transmission band for each flow preliminarily.

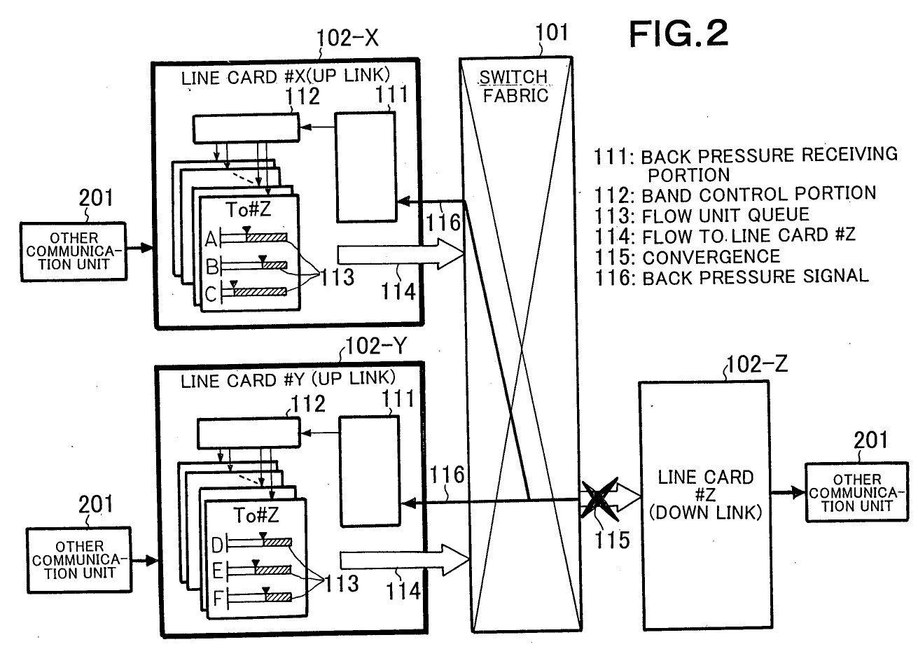

Referring to FIG. 2, the chassis type router of this embodiment has a switch fabric 101 and line cards 102-X, 102-Y, 102-Z connected to the switch fabric 101 through a back plane. Each line card 102 has a back pressure receiving portion 111, a band control portion 112 and flow unit queues 113. Each flow unit queue 113 is a queue provided for each flow.

The line card 102 is connected to other communication unit 201 through a communication line (not shown) and receives packets arrived at its own router and sends packets to be dispatched from its own router. An up link line card is located on a preceding stage relative to the switch fabric 101 and has a function for transferring packets flowing into the router to the switch fabric 101.

On the other hand, a down link line card is located on a post stage relative to the switch fabric 101 and has a function for sending out packets transferred from the switch fabric 101. The line card 102 and the switch fabric 101 are separated physically and are connected through a back plane (not shown).

The switch fabric 101 is connected to the plural line cards 102-X, 102-Y and 102-Z and located in the middle of the up link line card and the down link line card. A packet received by the up link line card is sent to the switch fabric 101 and the switch fabric 101 forwards that packet to an output port corresponding to the destination of that packet. If packets exceeding the processing capacity of a certain output port flow in, a back pressure signal accompanying output port discrimination information which discriminates a convergent output port is outputted to the up link line cards.

The back pressure receiving portion 111 receives the back pressure signal and analyzes control information therein.

The band control portion 112 controls a packet flow amount of each flow and limits the amount of the flow entering the convergent output port to the minimum guaranteed transmission band based on information analyzed by the back pressure receiving portion 111.

The flow unit queue 113 accumulates packets of each flow.

According to the present invention, by changing the method of using the back pressure signal dispatched from the switch fabric 101, both avoidance of convergence and guarantee of the minimum transmission band of each flow are achieved in the chassis type router.

Next, the embodiment of the invention will be described in more detail.

In FIG. 2, if convergence occurs in the output port, the switch fabric 101 outputs the back pressure signal 116 to the up link line card.

If the back pressure signal receiving portion 111 receives a back pressure signal 116 from the switch fabric 101, the back pressure signal receiving portion 111 discriminates an output port in convergent condition by seeing port discrimination information contained therein and sends output port discrimination information to the band control portion 112.

The band control portion 112 limits the output of a flow which is a control object from the flow unit queue 113 based on the received back pressure signal and the minimum guaranteed transmission band set up for each flow.

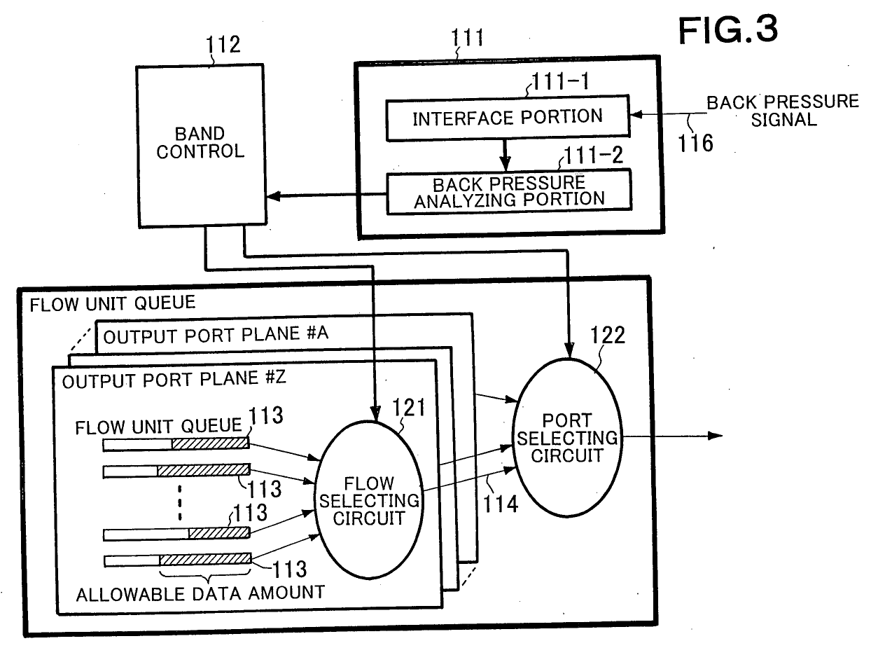

FIG. 3 shows a detailed structure of the band control circuit group shown in FIG. 2.

Referring to FIG. 3, an interface portion 111-1 serves as mainly a physical interface, receiving a back pressure signal dispatched from the switch fabric 101 so as to verify its effectiveness. If the back pressure signal is determined to be invalid because, for example, a nonexistent port is specified, the back pressure signal is neglected.

A back pressure analyzing portion 111-2 picks up port discrimination information for discriminating the output port in convergent condition from the back pressure signal determined to be valid and sends the discrimination information to the band control portion 112.

Each flow unit queue 113 is provided for each flow as described above and a group of the flow unit queues which correspond to the same destination output port is regarded as an output port plane. Although there is only a single output port plane which corresponds to a certain destination output port on an up link line card, generally, the chassis type router has plural up link line cards and a flow contained in an output port plane of plural up link line cards which use a common destination output port is supplied to that destination output port.

A flow selecting circuit 121 is provided for each output port plane of each up link line card. The flow selecting circuit 121 time-division multiplexes packets stored in plural flow unit queues belonging to the same output port plane of the same up link line card, according to weighted round robin method which changes a time ratio depending on a rate.

Each up link line card is provided with a single port selecting circuit 122. The port selecting circuit 122 time-division multiplexes packets outputted from plural flow selecting circuits 121 belonging to the same up link line card according to the round robin method which changes its time ratio depending on the rate, and outputs the multiplexed packets to the switch fabric 101. Although an output of the port selecting circuit 122 contains packets addressed to different output port destinations, the switch fabric 101 carries each packet to the corresponding destination output port.

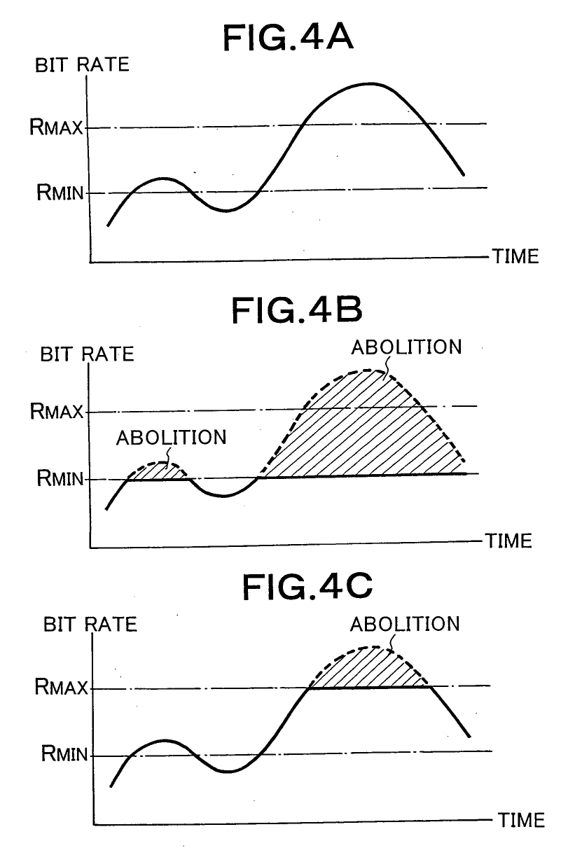

If no convergence occurs in a certain output port, packets are outputted from each flow unit queue of each output port plane, corresponding to that output port, of the up link line card at the same output rate as the input rate of packets flowing into that flow unit queue. FIG. 4A shows an example in which the output rate is not limited.

Contrary to this, if convergence occurs in a certain output port, packets outputted form each flow unit queue of an output port plane, corresponding to that output port, of each up link line card are controlled as follows. That is, if the input rate of packets flowing into the flow unit queue is less than a rate corresponding to the minimum guaranteed transmission band allocated to the flow unit queue, the packets are outputted at the same output rate as the input rate of packets flowing into the flow unit queue. On the other hand, if the input rate of packets flowing into the flow unit queue is over the rate corresponding to the minimum guaranteed transmission band allocated to the flow unit queue, a part of the packets are outputted at an output rate corresponding to the minimum guaranteed transmission band. This is achieved by abolishing another part of the packets inputted into the flow unit queue. FIG. 4B shows an example in which there are periods in which the output rate is limited. R_{MIN} in FIG. 4B indicates the minimum guaranteed transmission band.

The flow selecting circuit 121 outputs packets accumulated in each flow unit queue at a rate corresponding to the minimum guaranteed transmission band allocated to the flow unit queue at the maximum in the case of FIG. 4B. Therefore, the total rate of packets outputted from the flow selecting circuit 121 becomes a rate corresponding to the sum of the minimum guaranteed transmission bands allocated to all the flow unit queues belonging to the output port plane which the flow selecting circuit 121 belongs to at the maximum.

If there is no output port where convergence occurs, the port selecting circuit 122 evenly selects packets outputted from the flow selecting circuits 121 of all the output port planes belonging to the up link line card to which the port selecting circuit 122 belongs and outputs the selected packets to the switch fabric 101.

On the other hand, if convergence occurs in a certain output port (for example, output port #Z), the port selecting circuit 122 sets the output rate of packets outputted from the flow selecting circuit 121 of the output port plane corresponding to that output port to a rate corresponding to the sum of the minimum guaranteed transmission bands allocated to all the flow unit queues belonging to that output port plane, and packets outputted from the flow selecting circuits 121 of output port planes other than the output port plane corresponding to that output port are evenly selected. As a consequence, the port selecting circuit 122 settles the convergence of that output port and at the same time, realizes transmission of best effort by allocating unused transmission band to packets forwarded to the other output ports undergoing no convergence.

If convergence occurs in a certain output port, the maximum rate of packets supplied to that output port from the port selecting circuits 122 of all the up link line cards becomes the sum of the rates of packets outputted from the flow selecting circuits 121, each corresponding to the output port plane corresponding to that output port in each up link line card. Further, as described above, the maximum rate of packets outputted by the flow selecting circuit 121 of the output port plane corresponding to that output port becomes the sum of rates corresponding to the minimum guaranteed transmission bands allocated to all the flow unit queues belonging to that output port plane at the maximum. Therefore, adjusting the minimum guaranteed transmission band allocated to each flow unit queue of each output port plane on output basis while taking into account the content of a contract with user, and limiting the rate on the flow basis using the back pressure signal settle the convergence in the output port.

As described above, the flow selecting circuit 121 time-division multiplexes packets from plural flow unit queues belonging to the same output port plane of the same up link line card according to weighted round robin method and outputs the packets. Further, as described above, because the flow selecting circuit 121 outputs packets from each flow unit queue at a rate corresponding to the minimum guaranteed transmission band allocated to that flow unit queue, the total rate of the packets outputted from the flow selecting circuit 121 becomes the same as or less than a rate corresponding to the sum of the minimum guaranteed transmission bands each allocated to each flow unit queue belonging to the output port plane which that flow selecting circuit 121 belongs to. Therefore, if a certain flow unit queue is empty when it is selected, the flow selecting circuit 121 may proceed to selecting a next flow unit queue immediately according to the weighted round robin method. The total rate per output port of packets outputted from the flow selecting circuit 121 never increases unfairly in this case.

According to the first embodiment, convergence in a specific output port is eliminated while guaranteeing the minimum guaranteed transmission band of each flow.

### Second Embodiment

The second embodiment prevents a transmission band from being occupied by a specific flow solely while maintaining the effect of the first embodiment of eliminating convergence at a specific output port while guaranteeing the minimum guaranteed transmission band.

As explained above, FIG. 4B shows an example of the output rate of packets when the output rate is limited according to the back pressure signal. In this case, the output rate is limited by the minimum guaranteed transmission band.

Contrary to this, FIG. 4C shows an example of the output rate in a case where the output rate is not limited by the back pressure signal but the output rate is limited by the maximum limited transmission band. R_{MAX} in FIG. 4C indicates the maximum limited transmission band.

As evident from comparison of FIG. 4B with FIG. 4C, although the limit rate of output is different, the control method in a case of limiting the output rate with the maximum limited transmission band is the same as that in a case of limiting the output rate with the minimum guaranteed transmission bands.

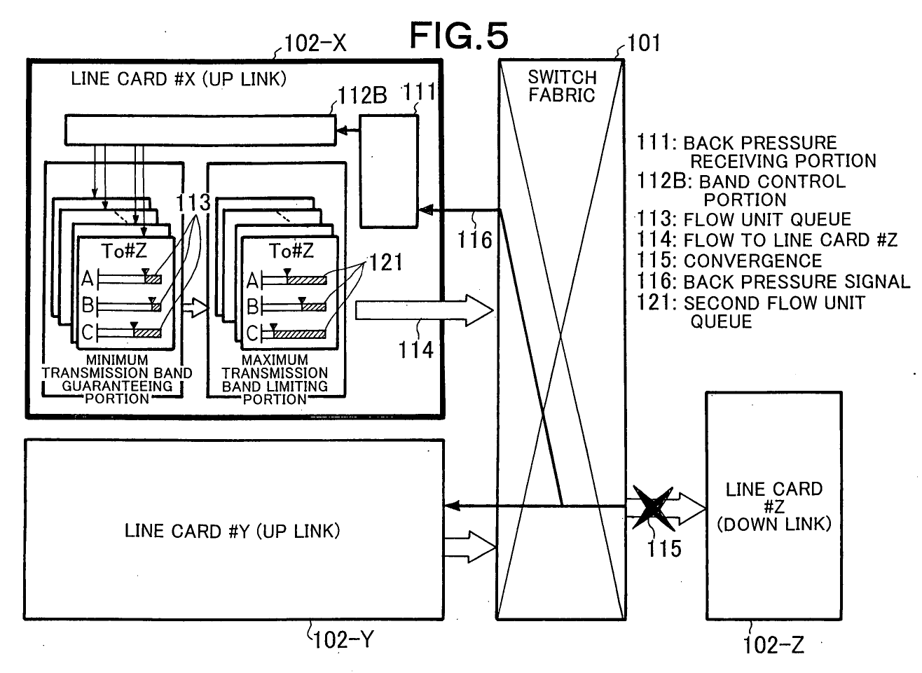

Thus, if the output port plane group shown in FIG. 2 or 3 is regarded as a minimum transmission band guaranteed portion 301, both guarantee of the minimum transmission band and limiting of the maximum transmission band are realized by providing the maximum transmission band limiting portion 302 having the same structure as the minimum transmission band guarantee portion 302 and connecting the minimum transmission band guarantee portion 301 with the maximum transmission band limiting portion 302 in series as shown in FIG. 5.

What makes the maximum transmission band limiting portion 302 different from the minimum transmission band guarantee portion 301 are as follows. First, while a minimum guaranteed transmission band is set up in each flow unit queue of the minimum transmission band guaranteed portion 301, the maximum limited transmission band is set up in each flow unit queue of the maximum transmission band limiting portion 302. Second, while when the back pressure signal is inputted to the minimum transmission band guarantee portion 301 as required, the minimum transmission band guaranteeing portion 301 limits the rate considering the minimum transmission band guarantee, the maximum transmission band limiting portion 302 always limits the rate actually or potentially without entry of the back pressure signal. Because the maximum limited transmission band set up in each flow unit queue of the maximum transmission band limiting portion 302 is larger than the minimum guaranteed transmission band set up in each flow unit queue of the minimum transmission band guaranteeing portion 301, the maximum transmission band limiting portion 302 has a occasion for actually operating only when no back pressure signal is inputted to the minimum transmission band guaranteeing portion 301.

According to the first embodiment, because the total rate of packets outputted from the flow selecting circuit 121 does not increase unfairly, if a certain flow unit queue is empty when it is selected according to the weighted round robin method, the flow selecting circuit 121 is permitted to proceed to selection of a next flow unit queue immediately. However, if this permission is made, the output rate of the packet in each flow unit queue exceeds a specified value in some cases. Therefore, the flow selecting circuit 121 included in the maximum transmission band limiting portion 302 of the second embodiment does not perform such a skipping operation.

The maximum transmission band limiting portion 302 may be installed on a down link of a line card as a next block of the switch fabric.

The present invention can be applied for limiting the transmission rate of each flow when convergence occurs in an output port of a router or the like.

What is claimed is:

1. A transmission band control method comprising the steps of:
sorting input packets into flows;
setting a minimum guaranteed transmission band for each flow; and
when a back pressure signal for limiting a supply of packets to an output port is generated, in each flow of one or more flows containing packets to be supplied to the output port, if an input rate of the packets contained in the flow is the same as or less than a rate corresponding to the minimum guaranteed transmission band set for the flow, supplying the packets contained in the flow to the output port at a same output rate as the input rate, while if the input rate of the packets contained in the flow exceeds the rate corresponding to the minimum guaranteed transmission band set for the flow, supplying the packets contained in the flow to the output port at an output rate corresponding to the minimum guaranteed transmission band set for the flow.

2. The transmission band control method according to claim 1, wherein the sorting is made based on the output port to which each input packet is supplied and on a user or a line number related to the input packet.

3. The transmission band control method according to claim 1, wherein each output port corresponds to one or more VLAN-IDs.

4. The transmission band control method according to claim 1, wherein plural flows corresponding the same output port are time-division multiplexed before supplied to the output port.

5. The transmission band control method according to claim 4, wherein the plural flows corresponding to the same output port are time-division multiplexed among plural up link line cards.

6. The transmission band control method according to claim 4, wherein the plural flows corresponding to the same output port are time-division multiplexed in a flow selecting circuit within each up link line card.

7. The transmission band control method according to claim 6, further comprising the step of determining a time ratio of the time-division multiplexing depending on the minimum guaranteed transmission bands of the plural flows.

8. The transmission band control method according to claim 7, further comprising the step of, if no packet exists in a certain flow, causing the flow selecting circuit to skip time allocation to the flow and to proceed to time allocation to a next flow.

9. The transmission band control method according to claim 6, wherein the plural flows time-division multiplexed by the flow selecting circuit are additionally time-division multiplexed with plural flows supplied to other output ports in a port selecting circuit within each up link line card.

10. The transmission band control method according to claim 9, further comprising the step of determining a time ratio of the time-division multiplexing in the port selecting circuit depending on the minimum guaranteed transmission bands of port planes,
wherein each port plane comprises plural flows corresponding to the same output port, and the minimum guaranteed transmission band of the port plane is a sum of the minimum guaranteed transmission bands each set for each flow in the port plane.

11. The transmission band control method according to claim 9, further comprising the step of reducing time allocation to plural flows supplied to an output port relating to the back pressure signal depending on the minimum guaranteed transmission band of the port plane,
wherein the port plane comprises the plural flows supplied to the output port relating to the back pressure signal, and the minimum guaranteed transmission band of the port plane is a sum of the minimum guaranteed transmission bands each set for each flow in the port plane.

12. The transmission band control method according to claim 11, further comprising the step of allocating a residual time generated as a result of reducing the time allocation to the plural flows supplied to the output port relating to the back pressure signal to other port planes.

13. The transmission band control method according to claim 1, further comprising the steps of:
setting a maximum limited transmission band for each flow; and
when no back pressure signal for limiting a supply of the packets to the output port is generated, in each flow of one or more flows containing packets to be supplied to the output port, if the input rate of the packets contained in the flow is the same as or less than a rate corresponding to the maximum limited transmission band set for flow, supplying the packets contained in the flow to the output port at a same output rate as the input rate, while if the input rate of the packets contained in the flow exceeds the rate corresponding to the maximum limited transmission band set for the flow, supplying the packets contained in the flow to the output port at an output rate corresponding to the maximum limited transmission band set for the flow.

14. A transmission band control system comprising:
a sorter adopted for sorting input packets into flows;
a first setter adopted for setting a minimum guaranteed transmission band for each flow; and
a first controller adopted for, when a back pressure signal for limiting a supply of packets to an output port is generated, in each flow of one or more flows containing packets to be supplied to the output port, if an input rate of the packets contained in the flow is the same as or less than a rate corresponding to the minimum guaranteed transmission band set for the flow, supplying the packets contained in the flow to the output port at a same output rate as the input rate, while if the input rate of the packets contained in the flow exceeds the rate corresponding to the minimum guaranteed transmission band set for the flow, supplying the packets contained in the flow to the output port at an output rate corresponding to the minimum guaranteed transmission band set for the flow.

15. The transmission band control system according to claim 14, wherein the sorting is made based on the output port to which each input packet is supplied and on a user or a line number related to the input packet.

16. The transmission band control system according to claim 14, wherein each output port corresponds to one or more VLAN-IDs.

17. The transmission band control system according to claim 14, wherein plural flows corresponding the same output port are time-division multiplexed before supplied to the output port.

18. The transmission band control system according to claim 17, wherein the plural flows corresponding to the same output port are time-division multiplexed among plural up link line cards.

19. The transmission band control system according to claim 17, further comprising a flow selecting circuit within each up link line card adopted for time-division multiplexing the plural flows corresponding to the same output port.

20. The transmission band control system according to claim 19, further comprising a first determiner adopted for determining a time ratio of the time-division multiplexing depending on the minimum guaranteed transmission bands of the plural flows.

21. The transmission band control system according to claim 20, further comprising a flow selecting circuit adopted for, if no packet exists in a certain flow, skipping time allocation to the flow and proceeding to time allocation to a next flow.

22. The transmission band control system according to claim 19, further comprising a port selecting circuit within each up link line card adopted for additionally time-division multiplexing the plural flows time-division multiplexed by said flow selecting circuit with plural flows supplied to other output ports.

23. The transmission band control system according to claim 22, further comprising a second determiner adopted for determining a time ratio of the time-division multiplexing in said port selecting circuit depending on the minimum guaranteed transmission bands of port planes,
wherein each port plane comprises plural flows corresponding to the same output port, and the minimum guaranteed transmission band of the port plane is a sum of the minimum guaranteed transmission bands each set for each flow in the port plane.

24. The transmission band control system according to claim 22, wherein said port selecting circuit reduces time allocation to plural flows supplied to an output port relating to the back pressure signal depending on the minimum guaranteed transmission band of the port plane,
wherein the port plane comprises the plural flows supplied to the output port relating to the back pressure signal, and the minimum guaranteed transmission band of the port plane is a sum of the minimum guaranteed transmission bands each set for each flow in the port plane.

25. The transmission band control system according to claim 24, wherein said port selecting circuit allocates a residual time generated as a result of reducing the time allocation to the plural flows supplied to the output port relating to the back pressure signal to other port planes.

26. The transmission band control system according to claim 14, further comprising:
a second setter adopted for setting a maximum limited transmission band for each flow; and
a second controller adopted for, when no back pressure signal for limiting a supply of the packets to the output port is generated, in each flow of one or more flows containing packets to be supplied to the output port, if the input rate of the packets contained in the flow is the same as or less than a rate corresponding to the maximum limited transmission band set for flow, supplying the packets contained in the flow to the output port at a same output rate as the input rate, while if the input rate of the packets contained in the flow exceeds the rate corresponding to the maximum limited transmission band set for the flow, supplying the packets contained in the flow to the output port at an output rate corresponding to the maximum limited transmission band set for the flow.
